(19) United States
(12) Patent Application Publication
(10) Pub. No.: US 2009/0226202 A1
(43) Pub. Date: Sep. 10, 2009

(54) FIXING DEVICE, TEMPERATURE CONTROLLING METHOD AND IMAGE FORMING APPARATUS

(75) Inventors: Satoshi KINOUCHI, Shinjyuku-ku (JP); Kazuhiko Kikuchi, Yokohama-shi (JP); Hiroshi Nakayama, Mishima-shi (JP); Toshihiro Sone, Yokohama-shi (JP)

Correspondence Address: PATTERSON & SHERIDAN, L.L.P., 3040 POST OAK BOULEVARD, SUITE 1500, HOUSTON, TX, 77056, US

(73) Assignee: Kabushiki Kaisha Toshiba, Tokyo (JP)

(21) Appl. No.: 12/398,304

(22) Filed: Mar. 5, 2009

Related U.S. Application Data
(60) Provisional application No. 61/034,892, filed on Mar. 7, 2008.

(51) Int. Cl. G03G 15/20

(52) U.S. Cl. 399/69; 399/334; 399/43; 399/44

(57) ABSTRACT

A fixing device includes: a heat member; a press member; a plurality of heat source members; temperature detectors; temperature control units that control outputs from the respective heat source members so that detected temperatures that the respective temperature detectors detect become preset controlled temperature; a processing target determining unit that determines whether at least one sheet to be subjected to the fixation includes a medium size sheet; and a controlled temperature determining unit that sets the controlled temperature of the heat source member corresponding to the temperature detection target area where the sheet does not pass to a temperature higher than the controlled temperature of the heat source member corresponding to the temperature detection target area where the sheet passes if it is determined that the medium size sheet is included.

### CROSS-REFERENCE TO RELATED APPLICATION

This application is based upon and claims the benefit of priority from: U.S. provisional application 61/034,892, filed on Mar. 7, 2008, the entire contents of each of which is incorporated herein by reference.

### TECHNICAL FIELD

Described below is a temperature control technology in fixation in image formation for forming an image on a sheet.

### BACKGROUND

In fixation for forming an image by fusing a developer image on a sheet, it is very important to control a heating temperature at a constant level in view of formation of a satisfactory image.

The fixation as described above is generally carried out by nipping and carrying the sheet formed with the developer image with a pair of rollers at least one of which is heated. As a heat source member for heating the rollers, halogen lamp, induction heat coil (so-called an IH coil), or the like is used. A heating system using the induction heat coil is able to respond to a demand for energy saving since it provides a high heat-exchanging efficiency.

A fixing device which carries out the fixation includes a pair of rollers having a length corresponding to a sheet of a maximum size that the device supports (hereinafter, referred to as “full size”), and the fixation for sheets of smaller sizes is also carried out with these rollers. Therefore, when carrying out the fixation for a sheet of a small size, it is necessary to control the temperature distribution of the roller in the direction of an axis of rotation such as preventing the temperature in areas where the sheets do not pass from being heated to an excessively high temperature.

JP-A-2000-206813 and JP-A-2001-312178 disclose technologies to uniformize the temperature distribution of fixing rollers in the direction of an axis of rotation thereof by arranging a plurality of induction heat coils at different positions in terms of the direction of the axis of rotation of the fixing rollers and changing the allocation of electric energy to be supplied to the respective coils. A device disclosed in JP-A-2000-206813 detects the temperature difference between the center and end portions of the fixing rollers and changes the allocation of the electric energy to be supplied to the coils according to the temperature difference. In contrast, A device disclosed in JP-A-2001-312178 determines the size of a sheet to be applied with the fixation and changes the allocation of the electric energy to be supplied to the coils according to the sheet size.

JP-A-2007-226125 discloses a technology to arrange degaussing coils at both end portions of fixing rollers and activate the degaussing coils when fixing sheets of smaller sizes thereby preventing areas where the sheets do not pass from being heated to an excessively high temperature.

However, the temperature control technologies disclosed in JP-A-2000-206813, JP-A-2001-312178, and JP-A-2007-226125 might be able to prevent a partial temperature rise (specifically, an excessive temperature rise on both sides) of the fixing rollers generated when processing the sheets of small sizes, but it might not be able to prevent a temperature fall at joints between the induction heat coils caused by the sheet size.

### SUMMARY

Accordingly, it is an object of the present invention to provide a technology that is able to prevent a temperature fall at joints between heat source members caused by the sheet size and uniformize the temperature distribution when carrying out fixation for forming an image by fixing a developer on the sheet.

In order to solve the problem as described above, there is provided a fixing device including: a heat member that heats a sheet formed with a developer image thereon; a press member that is brought into press-contact with the heat member and nips and carries the sheet in cooperation with the heat member; a plurality of heat source members that are arranged at positions different from each other in a direction orthogonal to a direction to carry the sheet and heat the heat member; temperature detectors that are arranged corresponding to the respective heat source members and detect the temperatures of heat target areas that the respective heat source members heat; temperature control units that control outputs from the respective heat source members so that temperatures that the respective temperature detectors detect become preset controlled temperature; a processing target determining unit that determines whether at least one sheet to be subjected to fixation includes a medium size sheet which passes while lying astride both adjacent heat target areas but passes only one of temperature detection target areas; and a controlled temperature determining unit that sets the controlled temperature of the heat source member corresponding to the temperature detection target area where the sheet does not pass to a temperature higher than the controlled temperature of the heat source member corresponding to the temperature detection target area where the sheet passes if it is determined that the medium size sheet is included.

There is also provided a temperature controlling method to be performed when fixation is carried out by allowing the sheet to pass through a plurality of heat areas formed at different positions in a direction orthogonal to a direction to carry a sheet formed with a developer image thereon, including: determining whether at least one sheet to be subjected to the fixation includes a medium size sheet which passes while lying astride the both adjacent heat areas but passes only one of temperature detection target areas; and setting the controlled temperature of the heat area corresponding to the temperature detection target area where the sheet does not pass to a temperature higher than the controlled temperature of the heat area corresponding to the temperature detection target area where the sheet passes if it is determined that the medium size sheet is included.

The invention also provides an image forming apparatus including: an image data acquiring unit that acquires data of image to be formed; a developer image forming unit that forms a developer image on a sheet on the basis of the image data from the image data acquiring unit; the fixing device that carries out fixation on the sheet formed with the developer image according to claim 1; a sheet carrying unit that supplies the sheet to the developer image forming unit and discharges the sheet after the fixation from the apparatus; and an action control unit that controls an image forming action of the apparatus.

The invention also relates to a fixing device including: a heating means for heating a sheet formed with a developer image thereon; a pressurizing means being brought into press-contact with the heating means for nipping and carrying the sheet in cooperation with the heating means; a plurality of heat source means being arranged at positions different from each other in a direction orthogonal to a sheet carrying direction for heating the heating means; temperature detecting means being arranged corresponding to the respective heat source means for detecting the temperatures of heat target areas that the respective heat source means heat; temperature control means for controlling outputs from the respective heat source means so that temperatures that the respective temperature detecting means detects become preset controlled temperature; and controlled temperature determining means for determining the controlled temperature so as to prevent the temperature of the heating member at a portion corresponding to a joint between the adjacent heating means from decreasing at the time of the fixation.

### DESCRIPTION OF THE DRAWINGS

FIG. 1 is a vertical cross-sectional view showing a schematic configuration of an image forming apparatus provided with a fixing device;

FIG. 2 is a vertical cross-sectional view of the fixing device according to a first embodiment;

FIG. 3 is a side view of the fixing device (including a functional block) according to the first embodiment;

FIG. 4 is a top view of the fixing device according to the first embodiment;

FIG. 5 is a drawing for explaining a relation among a sheet that the fixing device processes, heat target areas, and temperature detection positions according to the first embodiment;

FIG. 6 is a drawing for explaining the relation among the sheet that the fixing device processes, the heat target areas, and the temperature detection positions according to the first embodiment;

FIG. 7 is a drawing for explaining the relation among the sheet that the fixing device processes, the heat target areas, and the temperature detection positions according to the first embodiment;

FIG. 8 is a circuit drawing showing a control system of the fixing device according to the first embodiment;

FIG. 9 is a drawing for explaining a temperature distribution when the fixing device processes a sheet of a full size according to the first embodiment;

FIG. 10 is a drawing for explaining a temperature distribution when the fixing device processes a sheet of a medium size according to the first embodiment;

FIG. 11 is a drawing for explaining the temperature distribution when the fixing device processes the sheet of the medium size according to the first embodiment;

FIG. 12 is a drawing for explaining a temperature distribution when the fixing device processes a sheet of a small size according to the first embodiment;

FIG. 13 is a side view of the fixing device (including a functional block) according to a second embodiment;

FIG. 14 is a side view of the fixing device (including a functional block) according to a third embodiment;

FIG. 15 is a flowchart showing a flow of a temperature control by the fixing device according to the third embodiment; and

FIG. 16 is a side view of the fixing device (including a functional block) according to a fourth embodiment.

### DETAILED DESCRIPTION

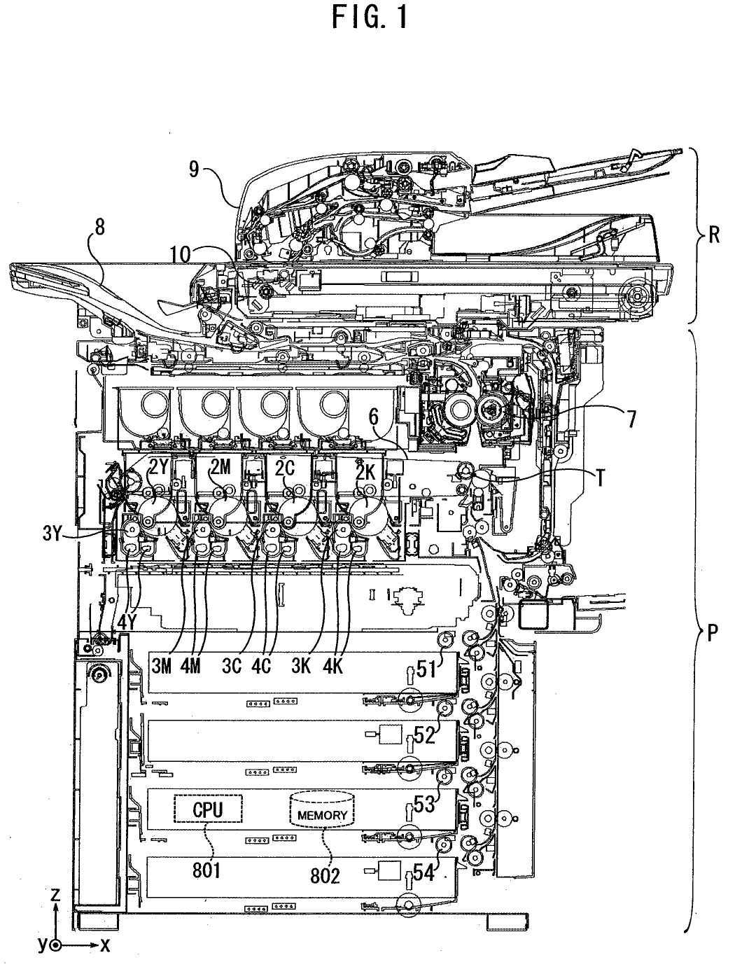

Referring now to the drawings, a fixing device will be described. FIG. 1 is a vertical cross-sectional view of an image forming apparatus (MFP: Multi Function Peripheral) having the fixing device.

As shown in FIG. 1, the image forming apparatus includes an image scanning unit R and an image forming unit P. The image scanning unit R has a function to scan an image from a sheet-type original or a book-type original and acquire image data to be formed. The image forming unit P has a function to form a developer image on a sheet such as a printing paper or a film on the basis of the image data that the image scanning unit R acquires from the original or image data transmitted from an external device. In other words, the image forming apparatus includes an image data acquiring unit.

A flow of general image formation that the image forming apparatus carries out will be described with an example of a process of color copying an image on a sheet-type original on a sheet below.

The image scanning unit R scans the image of the original placed at an image scanning position by an Auto Document Feeder (ADF) 9 or manually by a scanning optical system 10 and acquires image data.

Subsequently, the image forming unit P forms electrostatic latent images on photoconductive surfaces of photoconductive drums (2Y to 2K) for yellow (Y), magenta (M), cyan (C), and black (K) on the basis of the image data that the image scanning unit R acquires. Subsequently, developer stirred by mixers (4Y to 4K) in a developing unit is supplied to the photoconductive surfaces of the photoconductive drums (2Y to 2K) by developing rollers (3Y to 3K) and the electrostatic latent images are visualized on the photoconductive surfaces by the developer. The developer images visualized on the photoconductor surfaces are transferred to a surface of a rotating intermediate transfer belt 6 (primary transfer), and are carried to a position T where the developer images are transferred to the sheet (secondary transfer).

On the other hand, the sheet picked up from a cassette by one of pickup rollers 51 to 54 is transferred to the secondary transfer position T by a plurality of roller pairs, and the developer images are transferred from the intermediate transfer belt 6 at the secondary transfer position T.

Subsequently, the sheet to which the developer images are transferred is supplied to a fixing device 7. The fixing device 7 carries out fixation, described later in detail, to fix the developer images to the sheet.

The sheet to which the developer images are thermally fixed is carried in a carrying path by a plurality of carrying roller pairs and is discharged onto a discharge tray 8.

These processes in the image formation are realized by a CPU 801 which carries out a program stored in a memory 802. The memory 802 stores the program and various data to be used in the image processing.

### First Embodiment

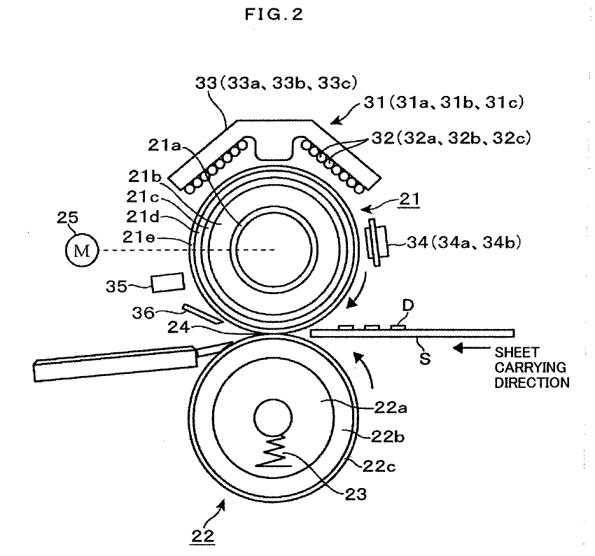

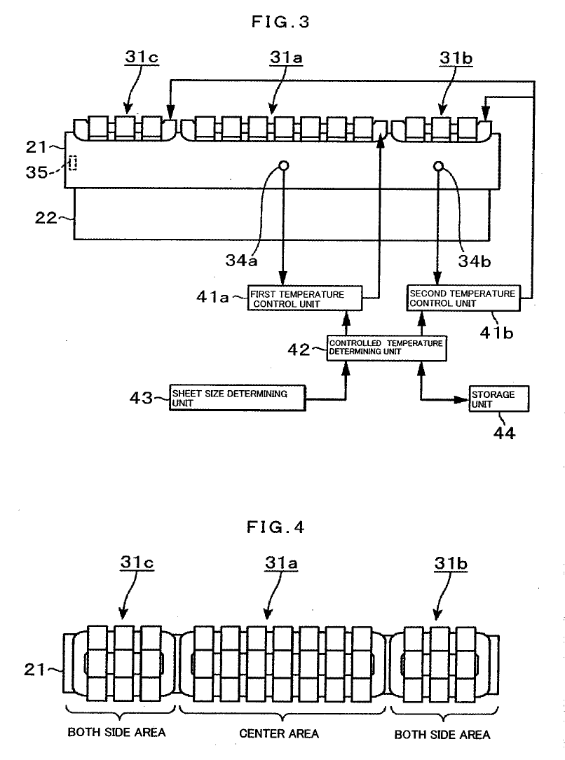

Referring now to FIG. 2 to FIG. 4, the fixing device according to the first embodiment will be described. FIG. 2 is a vertical cross-sectional view of the fixing device; FIG. 3 is a side view of the fixing device (including a functional block); and FIG. 4 is a top view of the fixing device.

The fixing device includes a heat roller (so-called a fixing roller) 21 as a heat member that heats a sheet S on which developer images D are transferred and a press roller 22 as a press member which comes into press-contact with the heat roller 21. The press roller 22 is brought into press-contact with the heat roller 21 by a pressurizing mechanism 23 so as to maintain a constant nip width so that a nip 24 is formed. The heat roller 21 is driven by a drive motor 25 and rotates in the direction of an arrow in the drawing. The press roller 22 is in press-contact with the heat roller 21, and hence rotates in association with the rotating heat roller 21. In other words, the heat roller 21 and the press roller 22 cooperatively nip and carry the sheet S formed with the developer images D, apply heat and a pressure to the sheet S passing through the nip 24, and fuse and press-fit the developer images D.

The effective lengths of the heat roller 21 and the press roller 22 in the direction of an axis of rotation which substantially come into contact with the sheet S and heat the same are at least the same as or longer than the dimension of the full size sheet. The diameters of the rollers 21 and 22 may be 40 mm. The heat member is not limited to the heat roller 21 shown in FIG. 1, and a configuration including an endless belt (so-called a fixing belt) having a metallic conductive layer is also applicable.

The heat roller 21 has a configuration including a core metal 21a, a foamed rubber (so-called sponge) layer 21b, a metallic conductive layer 21c, a solid rubber layer 21d, and a mold release layer 21e laminated in sequence from the side of the axis of rotation. For example, a configuration in which the thickness of the foamed rubber layer 21b is 5 mm, the thickness of the metallic conductive layer 21c is 40 μm, the thickness of the solid rubber layer 21d is 200 μm, and the thickness of the mold release layer 21e is 30 μm is applicable. The material of the metallic conductive layer may be nickel, stainless, aluminum, or a composite material including stainless and aluminum.

The press roller 22 has a configuration including a core metal 22a, a rubber layer 22b such as silicon rubber or fluorine-contained rubber, and a mold release layer 22c laminated in sequence from the side of the axis of rotation For example, a configuration in which the thickness of the rubber layer 22b is 1 mm and the thickness of the mold release layer 22c is 30 μm is applicable.

An induction heat coil (so called, an IH coil) 31 as a heat source member is arranged on the outer periphery of the heat roller 21 so as to oppose thereto via a space. The induction heat coil 31 includes a litz wire 32 including a plurality of wires such as copper wires insulated from each other by heat resistant polyamide imide or the like tied up together into a bundle. The induction heat coil 31 generates a magnetic flux and an eddy-current in the heat roller 21 if a high-frequency current is applied from an exciting circuit (so-called an inverter circuit) described later. The heat roller 21 is heated by Joule heat generated by the eddy-current and a resistance of the heat roller 21. The induction heat coil 31 includes a magnetic body core 33 bent in cross-section so as to surround the outer periphery of the heat roller 21, so that the generated magnetic flux concentrates on the heat roller 21.

The induction heat coil 31 may have a plurality of induction heat coils arranged at different positions from each other in the direction of the axis of rotation of the heat roller 21. As shown in FIG. 3 and FIG. 4, a first induction heat coil 31a and second induction heat coils (31b, 31c) are arranged in the direction of the axis of rotation of the heat roller 21. The first induction heat coil 31a is adapted to heat a center area in the direction of the axis of rotation of the heat roller 21 as a heat target area. The second induction heat coils (31b, 31c) heat both side areas in the direction of the axis of rotation of the heat roller 21 as heat target areas. The first induction heat coil 31a and the second induction heat coils (31b, 31c) are electrically isolated and are controlled in output independently. Two coils that constitute the second induction heat coils (31b, 31c) are electrically connected in series and are controlled equally in output. The entire length of the coil formed of the plurality of induction heat coils 31a to 31c is, for example, 320 mm, and the length of the first induction heat coil is, for example, 200 mm.

As shown in FIG. 3, the positions of a first temperature sensor 34a and a second temperature sensor 34b in the direction of the axis of rotation of the heat roller 21 are different from each other. The first temperature sensor 34a detects the temperature at the center of the heat roller 21 in the direction of the axis of rotation, that is, the temperature of the heat target area of the first induction heat coil 31a. The second temperature sensor 34b detects the temperature of the sides of the heat roller 21 in the direction of the axis of rotation, that is, the temperature of the heat target areas of the second induction heat coil 31b. The first and second temperature sensors 34a and 34b may be thermopile-type non-contact temperature sensors which detect infrared rays. The temperatures that the first and second temperature sensors 34a and 34b detect are used for output control of the first and second induction heat coils (31a to 31c).

The fixing device includes a third temperature sensor 35 that detects the temperature of the heat roller 21. The third temperature sensor 35 is arranged at a position outside the area where the sheet of a full size passes in the direction of the axis of rotation of the heat roller 21. The third temperature sensor 35 may be a contact-type thermistor. The temperatures that the third temperature sensor 35 detects are used for stopping a heating action by interlocking when the temperature of the heat roller 21 rises to an abnormal level.

As shown in FIG. 2, the fixing device includes a separating claw 36 that prevents the sheet S from adhering to the heat roller 21.

Referring now to FIG. 3, functions of the fixing device will be described. A first temperature control unit 41a has a function to feedback control the output from the first induction heat coil 31a so that the temperature that the first temperature sensor 34a detects is kept at a predetermined controlled temperature. A second temperature control unit 41b has a function to feedback control the outputs from the second induction heat coils (31b, 31c) so that the temperature that the second temperature sensor 34b detects is kept at a predetermined controlled temperature.

A controlled temperature determining unit 42 has a function to determine the controlled temperatures of the first induction heat coil 31a and the second induction heat coils (31b, 31c) on the basis of the size of the sheet S to be subjected to the fixation, and provide determined temperature data respectively to the first and second temperature control units 41a and 41b. In particular, the controlled temperature determining unit 42 determines whether the controlled temperatures of the first induction heat coil 31a and the second induction heat coils (31b, 31c) are to be equalized or to be different temperatures if the size of the sheet S to be subjected to the fixation has a relation as shown in FIG. 5 to FIG. 7 described later between the heat target areas of the respective coils and the temperature detection positions of the respective temperature sensors.

A sheet size determining unit 43 as a processing target determining unit has a function to determine the size of the sheet S to be subjected to the fixation according to size data of the sheet S that the a user specifies via an operation panel (not shown) of the device or size data that a sensor (not shown) disposed in a sheet carrying path of the image forming apparatus shown in FIG. 1 or a selected cassette identifies and provide determined size data to the controlled temperature determining unit 42. A storage unit 44 includes, for example, a hard disk or a flush memory, and stores various programs or various data used for the fixation. The functions that the fixing device can use are realized by the CPU 801 activating the program stored in the storage unit 44, the memory 802, and the like.

Referring now to FIG. 5 to FIG. 7, a method of determining the controlled temperature will be described.

As described above, the fixing device heats the center and the both sides of the heat roller 21 separately using the first induction heat coil 31a and the second induction heat coils (31b, 31c) controlled in output independently. Therefore, the sheet S to be subjected to the fixation is classified into three cases as schematically shown in FIG. 5 to FIG. 7 in terms of the relation between the heat target area and the temperature detection position in the direction of the axis of rotation of the heat roller 21.

In a first case, as shown in FIG. 5, the sheet S to be subjected to the fixation passes both through a center heat target area 51a and a side heat target area 51b and also both through a center temperature-detection position 52a and a side-temperature detection position 52b. The sheet size corresponding to the first case is referred to as “full size”. For example, in the case of sheets according to JIS standard, A4 size and A3 size correspond to the first case. The temperature detection positions 52a and 52b are target areas that the temperature sensors detect the temperature thereof.

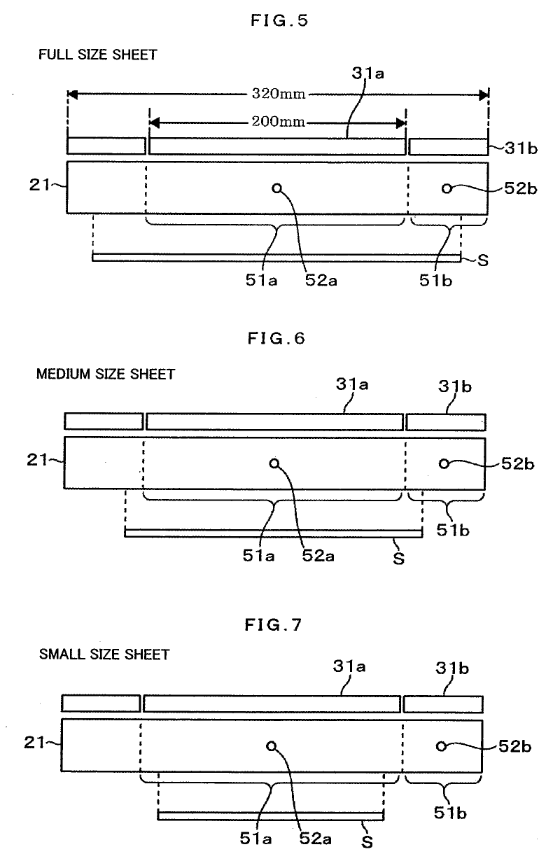

In a second case, as shown in FIG. 6, the sheet S to be subjected to the fixation passes both through the center heat target area 51a and the side heat target area 51b, but passes only the center temperature-detection position 52a. In other words, an end of the sheet S passes a position shifted to the center from the side temperature-detection position 52b. The sheet size corresponding to the second case is referred to as “medium size”. For example, in the case of the sheets according to JIS standard, A4-R size and B4 size correspond to the second case.

In a third case, as shown in FIG. 7, the sheet S to be subjected to the fixation passes only through the center heat target area 51a and the center temperature-detection position 52a. In other words, it is a case in which the area where the sheet S passes is included within the center heat target area 51a. The sheet size corresponding to the third case is referred to as “small size”. For example, in the case of the sheets according to JIS standard, B5-R size and a post card size correspond to the third case.

The controlled temperature determining unit 42 determines to equalize the controlled temperatures of the first induction heat coil 31a and the second induction heat coils (31b, 31c) if the size of the sheet S is the full size or the small size. In contrast, the controlled temperature determining unit 42 determines to set the controlled temperature of the second induction heat coil 31b to a higher temperature than the controlled temperature of the first induction heat coil 31a if the sheet size is the medium size. Since the lengths of the respective induction heat coils and the positions of the respective temperature sensors are defined on the basis of a device design, the sheets can be classified into the full size, the medium size, and the small size in advance. Therefore, data on the size-to-size basis relating to which control is to be carried out set in advance may be stored in the storage unit 44. The sheets classified as the medium size include several sizes such as A4-R size or B4 size. Therefore, the temperature control which is in tune with the circumstances is achieved by changing the controlled temperature according to the fragmented sizes in the medium size when storing the data preset on the size-to-size basis.

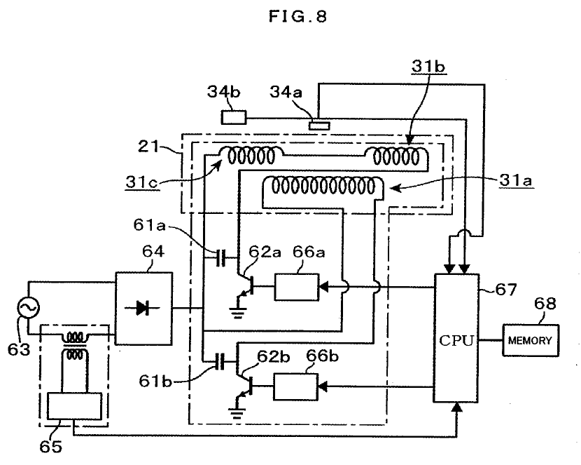

Returning back to FIG. 8, a control system which realizes the above-described functions will be described. As shown in FIG. 8, resonant capacitors 61a and 61b are connected to the first induction heat coil 31a and the second induction heat coils (31b, 31c) respectively in parallel, and switching elements 62a and 62b are connected to a resonance circuit to form an exciting circuit (inverter circuit). A DC power obtained by smoothing an AC power from a commercial AC power source 63 by a rectifying circuit 64 is supplied to the inverter circuit. A transformer 65 arranged on the upstream side of the rectifying circuit 64 detects a total power consumption and feeds back a power consumed by heating. Drive circuits are connected respectively to control terminals of the switching elements 62a and 62b. The drive circuits serve to apply a drive voltage to the control terminals of the switching elements 62a and 62b and drive (turn ON) the switching elements 62a and 62b. Control circuits 66a and 66b output timings to apply the drive voltage to the control terminals. The control circuits 66a and 66b determine the ON time, and change the power by changing the ON time while feeding back an input power. If the ON time is changed, one cycle of the current flowing in the induction heat coils (31a to 31c) is changed correspondingly, so that the drive frequency is changed as well. In other words, the frequency is changed within a range from 20 to 100 kHz by controlling the ON time to control the power value (output value) to be supplied to the induction heat coils (31a to 31c). Such action is controlled by a CPU 67. The CPU 67 reads a program or data from the memory 68 included in the storage unit 44 to carry out the control as described above.

Subsequently, a temperature controlling method when carrying out the fixation will be described. It is assumed that the fixing device is already completed with an initial activation and is in a ready state in which the temperature of the heat roller 21 is raised to a predetermined temperature. For example, the first and second induction heat coils 31a to 31c heat the heat roller 21 to a temperature of 160° C. to assume the ready state. It is also assumed that the sheet S to be subjected to the fixation is formed with the developer images D in advance, for example, by the image forming unit P shown in FIG. 1.

In such a state, the sheet size determining unit 43 of the fixing device determines the size of the sheet S to be subjected to the fixation. The controlled temperature determining unit 42 determines whether to equalize the controlled temperatures of the center and the both sides or to set the controlled temperature of the both sides to a higher temperature than the center on the basis of the determined size data. In the case of the full size sheet (for example, A4 size or A3 size), the controlled temperature determining unit 42 determines to equalize the controlled temperatures of the center and the both sides. The controlled temperature of the first induction heat coil 31a is set to 160° C. and the controlled temperature of the second induction heat coils (31b, 31c) is set to 160° C.

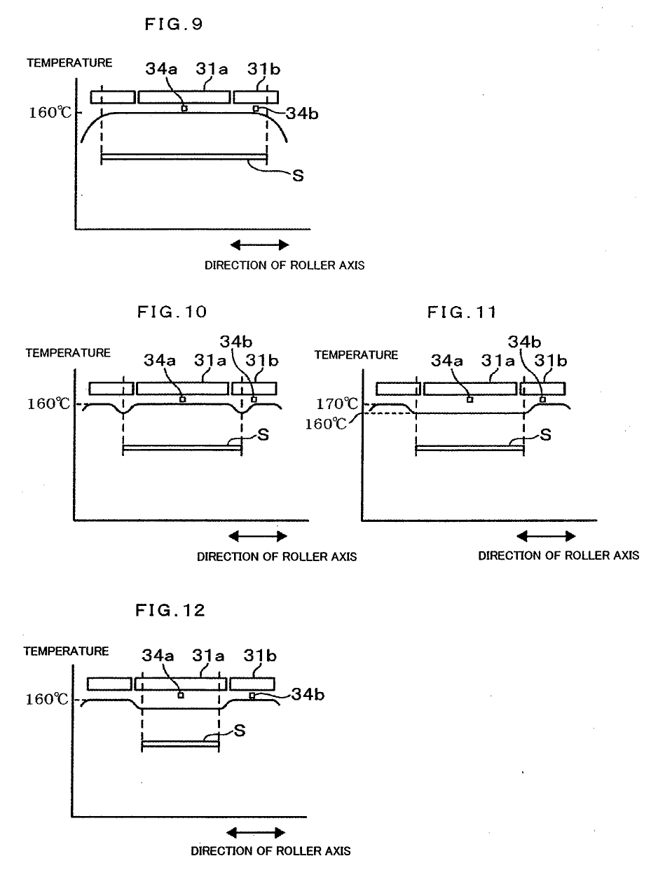

In the case of the full size sheet S, since the calorific power that the sheet S passing through the nip 24 absorbs is substantially the same between the center and the both sides, as shown schematically in FIG. 9, the temperature distribution in the area where the sheet S passes in the direction of the axis of rotation of the heat roller 21 is substantially uniform.

In contrast, in the case of the medium size sheet S (for example, A4R size or B4 size), the controlled temperature determining unit 42 determines to set the controlled temperature of the both sides to a temperature higher than that of the center. The controlled temperature of the first induction heat coil 31a is set to 160° C. and the controlled temperature of the second induction heat coils (31b, 31c) is set to 170° C.

As described above, although the medium size sheet S lies astride both the heat target areas 51a and 51b at the center and the both sides, the widthwise end of the sheet S passes a position shifted from the temperature detection position 52b on the side to the center. Therefore, if the controlled temperatures of the center and the both sides are equalized as in the case of the full size sheet, as shown in schematically in FIG. 10, a temperature fall occurs at the joints between the adjacent coils. In other words, since the sheet S passes the position shifted from the temperature detection position 52b on the side, the temperature that the temperature sensor 34b detects is higher than the temperature of a portion where the sheet S passes. Therefore, the calorific power to be supplied to the side by feedback is insufficient, and the temperature fall occurs at the joints between the coils.

Therefore, in the case of the medium size sheet S, the temperature distribution in the area where the sheet S passes in the direction of the axis of rotation of the heat roller 21 is substantially uniformized as schematically shown in FIG. 11 by setting the controlled temperature of the both sides to a temperature 10° C. higher.

Although the temperature of areas on the both sides where the sheet S does not pass is increased by 10° C. as shown in FIG. 11 by setting the controlled temperature on the both sides to a temperature 10° C. higher, it is not a temperature to affect the heat-resistant temperature of the heat roller 21, and not a temperature to cause a hot offset even though the full size sheet S passes subsequently.

In contrast, in the case of the small size sheet S (for example, B5-R size or post card size), the controlled temperature determining unit 42 determines to equalize the controlled temperatures between the center and the both sides. The controlled temperature of the first induction heat coil 31a is set to 160° C. and the controlled temperature of the second induction heat coils (31b, 31c) is set to 160° C.

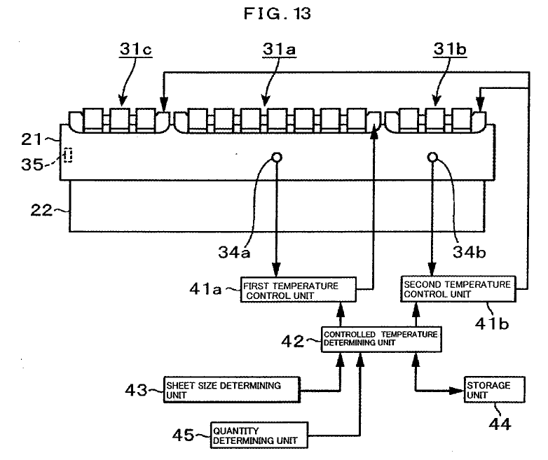

In the case of the small size sheet S, the width of the sheet S in the direction of the axis of rotation of the heat roller 21 is included within the center heat target area 51a. Therefore, the portion from which the heat is absorbed substantially by the sheet S is only the center heat target area 51a. Therefore, even though the control to equalize the controlled temperatures of the center and the both sides, the temperature fall does not occur at the joints between the coils as schematically shown in FIG. 12, and the temperature distribution in the area where the sheet S passes in the direction of the axis of rotation of the heat roller 21 is substantially uniformized.

As described above, according to the first embodiment, the temperature fall at the joints between the coils caused by the size of the sheet S is prevented, so that the temperature distribution is uniformized. Consequently, the fixation which forms satisfactory images on the sheets S of any sizes such as the full size, the medium size, and the small size is achieved.

If the heat roller 21 is divided into sections for heating using the plurality of induction heat coils, the temperature fall at the joints between the coils is prevented by dividing the heated area into the number corresponding to the number of sizes of the sheets that the device processes. However, in the actual devices, the number of coils is smaller than the number of sizes of the sheets that the device processes in many cases due to the problems of rising of the cost or upsizing of the device. The device in the first embodiment has an advantage such that the fixation is carried out with uniform temperature distribution in the direction of the axis of the rotation with respect to the sheets S of various sizes even with a small number of induction heat coils.

### Second Embodiment

Subsequently, a second embodiment will be described.

The second embodiment is a modification of the first embodiment described above. As shown in FIG. 13, the second embodiment is different from the first embodiment in that a quantity determining unit 45 that determines the numerical quantity of sheets to be subjected to the fixation is provided, and the temperature control is carried out on the basis of the size and the numerical quantity of the sheets to be subjected to the fixation.

The quantity determining unit 45 has a function to determine the numerical quantity of the sheets S to be subjected to the fixation according to the data on the number of copies that the user specifies via the operation panel (not shown) of the apparatus or data on the numerical quantity of the sheets S passed through the sheet carrying path or the like of the image forming apparatus shown in FIG. 1 identified by a sensor (not shown) arranged therein or the selected cassette and provide the determined data on the number to the controlled temperature determining unit 42.

If the numerical quantity of the sheet S to be subjected to the fixation continuously is more than a predetermined numerical quantity, the controlled temperature determining unit 42 determines the controlled temperature on the basis of the corresponding size of the sheet S. The numerical quantity of sheets to be subjected to the fixation continuously is, for example, the numerical quantity of sheets to be subjected to the fixation in one job. For example, if the numerical quantity of sheets is thirty or more, the controlled temperature is determined on the basis of the corresponding size of the sheets S. In other words, if thirty or more the full size or the small size sheets S are to be subjected to the fixation continuously, the controlled temperature determining unit 42 determines to equalize the controlled temperature of the first induction heat coil 31a and the second induction heat coils (31b, 31c). If thirty or more the medium size sheets S are to be subjected to the fixation continuously, the controlled temperature determining unit 42 determines to set the controlled temperature of the first induction heat coil 31a to be higher than the controlled temperature of the second induction heat coils (31b, 31c).

For example, if the fixation is to be carried out alternately for the full size sheets S and the medium size sheets S, occurrence of a state in which the controlled temperature is changed frequently is prevented by controlling only on the basis of the size of the sheet S, whereby the temperature control which is in tune with the circumstances is achieved.

### Third Embodiment

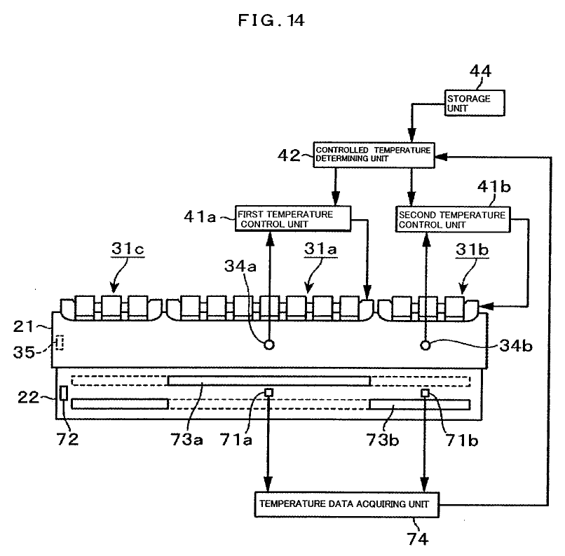

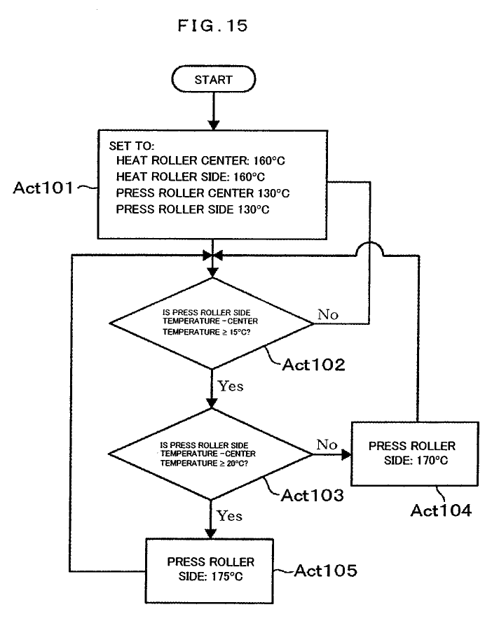

Referring now to FIG. 14 and FIG. 15, a third embodiment will be described. The third embodiment is a modification of the first embodiment described above. The third embodiment is different from the first embodiment in that the temperature of the press roller 22 is detected and the controlled temperature is determined on the basis of the detected temperature instead of determining the controlled temperature on the basis of the size of the sheet S as in the first embodiment.

In other words, the temperature distribution of the press roller 22 in the direction of the axis of rotation which is changed by the sheet S passing through the nip 24 is detected, and the controlled temperatures of the first induction heat coil 31a and the second induction heat coils (31b, 31c) are determined on the basis of a change in temperature distribution.

As shown in FIG. 14, the fixing device includes a fourth temperature sensor 71a and a fifth temperature sensor 71b that detect the temperatures of the press roller 22 at different positions in the direction of the axis of rotation. The fourth and fifth temperature sensors 71a and 71b are arranged at positions corresponding to the first and second temperature sensors 34a and 34b in the direction of the axis of rotation of the rollers. The fourth and fifth temperature sensors 71a and 71b may be, for example, non-contact thermistors, or thermopile-type non-contact temperature sensors which detect infrared rays. A sixth temperature sensor 72 is arranged at a position outside the area where the full size sheet passes in the direction of the axis of rotation of the press roller 22. The sixth temperature sensor 72 may be a contact-type thermistor.

The fixing device includes a first halogen lamp 73a and a second halogen lamp 73b arranged at positions different from each other in the direction of the axis of rotation of the press roller 22. The first halogen lamp 73a is adapted to heat the center area in the direction of the axis of rotation of the press roller 22. The second halogen lamp 73b is adapted to heat the both side areas in the direction of the axis of rotation of the press roller 22. The heat source member that heats the press roller 22 is not limited to the halogen lamp.

A temperature data acquiring unit 74 calculates the temperature difference between these positions from temperatures that the fourth temperature sensor 71a and the fifth temperature sensor 71b detect. The controlled temperature determining unit 42 determines the controlled temperatures of the first induction heat coil 31a and the second induction heat coils (31b, 31c) on the basis of the temperature difference described above.

Referring now to FIG. 15, a method of determining the controlled temperature when carrying out the fixation will be described. It is assumed that the fixing device is completed with the initial activation and is in a ready state in which the temperatures of the heat roller 21 and the press roller 22 are raised to predetermined temperatures (Act 101). The controlled temperatures of the heat roller 21 are 160° C. at the center and 160° C. at the both sides. The controlled temperatures of the press roller 22 are 130° C. at the center and 130° C. at the both sides.

When the fixation is started in such a state, the temperature data acquiring unit 74 determines whether the temperature difference (=temperature at the sides (° C.)−temperature at the center (° C.)) that the fourth and fifth temperature sensors 71a and 71b detect is 15° C. or more or not (Act 102). If the temperatured at a acquiring unit 74 determines that the temperature difference is smaller than 15° C. (No in Act 102), the controlled temperature determining unit 42 maintains the controlled temperature in Act 101.

In contrast, if the temperature data acquiring unit 74 determines that the temperature difference is 15° C. or more (Yes in Act 102), the temperature data acquiring unit 74 determines whether the temperature difference is 20° C. or more or not. If the temperature data acquiring unit 74 determines that the temperature difference is smaller than 20° C. (No in Act 103), the controlled temperature determining unit 42 determines to change the controlled temperature of the both ends of the heat roller 21 to 170° C. for the control (Act 104).

If the temperature data acquiring unit 74 determines that the temperature difference is 20° C. or more (Yes in Act 103), the controlled temperature determining unit 42 determines to change the controlled temperature of the both sides of the heat roller 21 to 175° C. for the control (Act 105).

As described above, when the full size sheet S passes through the nip 24, the temperatures at the center and the both sides fall by substantially the same temperature. Therefore, the temperature difference described above does not often exceed 15° C. In contrast, when the medium size and small size sheets S pass through the nip 24, the temperature of the press roller 22 falls more at the center than at the both sides thereof in the direction of the axis of rotation. Such the temperature change is remarkable when a plurality of (or a plurality of pages of) the sheets S pass continuously through the nip 24. Therefore, the temperature distribution of the press roller 22 in the direction of the axis of rotation is monitored, and if the temperature difference reaches or exceeds the predetermined value, it is determined that the sheets are the medium size sheets or the small size sheets, so that the controlled temperature of the both sides is determined to be risen. In other words, the temperature data acquiring unit 74 constitutes a processing target determining unit together with the fourth and fifth temperature sensors 71a and 71b. As described above, the small size sheet S does not pass the side heat target area (51b) on the both sides, even though the controlled temperature of the both sides is changed to 175° C., it does not often affect the temperature distribution of the area where the sheet passes. On the other hand, the temperature fall between the coils occurring when the medium size sheet S passes is prevented by rising the controlled temperature of the both sides as described above.

As described above, according to the third embodiment, the temperature fall at the joints between the coils caused by the size of the sheet S is prevented, so that the temperature distribution in the area where the sheet passes is uniformized in the same manner as the first embodiment. In particular, since the controlled temperature is determined according to the temperature difference on the side of the press roller 22, the controlled temperature is changed only when the medium size and small size sheets S are brought into the fixation continuously until a constant temperature difference is achieved. Therefore, if the fixation is to be carried out alternately for the sheets S of different sizes, occurrence of a state in which the controlled temperature is changed frequently is prevented by controlling only on the basis of the size of the sheet S the same as the first embodiment, whereby the temperature control which is in tune with the circumstances is achieved.

FIG. 14 shows an example in which the fourth and fifth temperature sensors 71a and 71b are arranged at almost the same positions as the first and second temperature sensors 34a and 34b in the direction of the axis of rotation of the rollers, the positions of arrangement are not limited thereto. For example, the fourth and fifth temperature sensors 71a and 71b may be arranged at positions closer to the joints between the coils than the first and second temperature sensors 34a and 34b. In this manner, by arranging the fourth and fifth temperature sensors 71a and 71b to the positions closer to the joints between the coils, the temperature fall at the joints between the coils is prevented.

The invention is not limited to detecting the temperatures of the plurality of positions of the press roller 22 by the fourth and fifth temperature sensors 71a and 71b and, for example, it is also possible to detect the temperatures near the positions corresponding to the joints between the coils on the press roller by one temperature sensor and determine the controlled temperature on the basis of a change in detected temperatures.

### Fourth Embodiment

Subsequently, a fourth embodiment will be described.

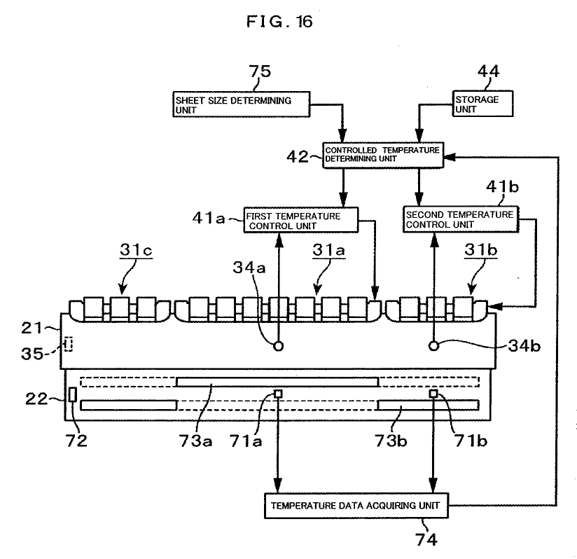

The fourth embodiment is a modification of the third embodiment described above. As shown in FIG. 16, a sheet size determining unit 75 that determines the size of the sheet S to be subjected to the fixation is provided. The sheet size determining unit 75 has the same configuration as the sheet size determining unit 43 in the first embodiment.

The fixing device carries out the method of determining the controlled temperature as shown in FIG. 15 as a general rule. However, if it is determined that the sheet S to be subjected to the fixation is of a small size, the controlled temperature determining unit 42 determines that the controlled temperature is set to a default value (that is, the controlled temperature in Act 101 in FIG. 15). In the method of determining the controlled temperature shown in FIG. 15, the controlled temperature of the both sides is set to a high temperature also for the small size sheet. However, if it is the small size sheet, the temperature fall at the joints between the coils does not occur often. Therefore, if it is determined to be the small size, the controlled temperature is returned to the original value, so that the temperature distribution in the area where the sheet passes in the direction of the axis of rotation of the heat roller 21 is uniformized.

### Fifth Embodiment

Subsequently, a fifth embodiment will be described.

The fifth embodiment is a modification of the first to fourth embodiments. In other words, a quantity determining unit that determining the numerical quantity of the sheets S to be subjected to the fixation is provide, and if it is determined that the numerical quantity of the sheets S to be subjected to the fixation continuously is determined to be a predetermined numerical quantity or more, a control to reduce the numerical quantity of the sheets S to be passed through the nip 24 per unit time (for example, lowers the process speed) is carried out. The quantity determining unit has the similar configuration to the quantity determining unit 45 in the second embodiment.

The temperature change occurring, for example, when the medium size sheets S pass through the nip 24 continuously is reduced by reducing the numerical quantity of the sheets S to be passed through the nip 24 per unit time, so that the temperature distribution in the area where the sheet passes in the direction of the axis of rotation of the rollers is uniformized.

In the respective embodiments described above, a configuration in which the center of the sheet S passes through the position near the center of the heat roller, so-called a “central paper feeding system” is employed is exemplified, the invention is not limited thereto. For example, a configuration in which the sheet S is carried at a position shifted on one of the sides in the sheet carrying direction, so-called a “one-side paper feeding system” is employed is also applicable.

In the embodiments described above, the device that senses the temperature of the heat roller or the press roller is not limited to the examples shown above and, needless to say, any of the contact type or non-contact type may be employed as appropriate.

The determination of the sheet size or the determination of the throughput of the sheets to be subjected to the fixation may be carried out during the fixation instead of performing prior to the actual fixation. In other words, the determination must simply be completed as a result before the controlled temperature determining unit determines the controlled temperature.

Specifically, as the sheet S to be subjected to the fixation in the respective embodiments described above, various sheets which are usable as printing media in the image forming apparatus such as copying sheets (so-called normal sheets), OHP films, card boards, post cards, and so on may be employed.

Although the specific aspects is described in detail, it is apparent for those skilled in the art that various modifications or improvement are possible as long as it does not deviate from the spirit and the scope in the invention.

According to the embodiments described above in detail, when carrying out the fixation for fixing developer on the sheet and forming an image, the temperature fall at the joints between the heat source members caused by the size of the sheet is prevented, so that the temperature distribution is uniformized.

What is claimed is:

1. A fixing device comprising:
a heat member that heats a sheet formed with a developer image thereon;
a press member that is brought into press-contact with the heat member and nips and carries the sheet in cooperation with the heat member;
a plurality of heat source members that are arranged at positions different from each other in a direction orthogonal to a direction to carry the sheet and heat the heat member;
temperature detectors that are arranged corresponding to the respective heat source members and detect the temperatures of heat target areas that the respective heat source members heat;
temperature control units that control outputs from the respective heat source members so that temperatures that the respective temperature detectors detect become preset controlled temperature;
a processing target determining unit that determines whether at least one sheet to be subjected to fixation includes a medium size sheet which passes while lying astride both adjacent heat target areas but passes only one of temperature detection target areas; and
a controlled temperature determining unit that sets the controlled temperature of the heat source member corresponding to the temperature detection target area where the sheet does not pass to a temperature higher than the controlled temperature of the heat source member corresponding to the temperature detection target area where the sheet passes if it is determined that the medium size sheet is included.

2. The device according to claim 1, wherein the processing target determining unit includes a sheet size determining unit that determines the size of the sheet to be subjected to the fixation.

3. The device according to claim 2, further comprising a quantity determining unit that determines the numerical quantity of the sheets to be subjected to the fixation continuously,
wherein if the numerical quantity of the sheets that the quantity determining unit determines exceeds a predetermined numerical quantity, the controlled temperature determining unit determines to change the controlled temperature on the basis of the size of the sheet that the sheet size determining unit determines.

4. The device according to claim 2, further comprising a storage unit that stores data on controlled temperatures preset for the respective sheet sizes,
wherein the controlled temperature determining unit reads the data on the controlled temperature corresponding to the sheet size that the sheet size determining unit determines from the storage unit and determines the controlled temperatures of the respective heat source members.

5. The device according to claim 1, wherein the processing target determining unit includes a second temperature detector that detects the temperature of the press member, and
the processing target determining unit determines whether the medium size sheet is included on the basis of a change in temperature that the second temperature detector detects.

6. The device according to claim 1,
wherein the processing target determining units includes a plurality of second temperature detectors that are arranged at positions different from each other in the direction orthogonal to the sheet carrying direction and detect the temperatures at a plurality of positions of the press member, and
The processing target determining unit determines whether the medium size sheet is included on the basis of the magnitude of the temperature difference of the temperatures that the plurality of second temperature detectors detect.

7. The device according to claim 6,
wherein the plurality of second temperature detectors are arranged at positions corresponding to the heat target areas that the respective heat source members heat in the direction orthogonal to the sheet carrying direction, and are arranged at positions closer to joints between the heat source members than the first temperature detector.

8. The device according to claim 5, wherein if the magnitude of the temperature difference reaches a preset threshold value or more, the controlled temperature determining unit changes the controlled temperature of the heat source member which does not pass the temperature detection target area to a temperature higher than the controlled temperature of the heat source member which passes the temperature detection target area.

9. The device according to claim 8, wherein the processing target determining unit further includes a sheet size determining unit that determines whether the sheet to be subjected to the fixation is a small size sheet which passes only the heat target area and the temperature detection target area of one of the adjacent heat source members,
wherein if the sheet size that the sheet size determining unit determines is a small size, the controlled temperature determining unit returns the controlled temperatures of the adjacent heat source members to the same temperature.

10. The device according to claim 1, further comprising:
a quantity determining unit that determines the numerical quantity of the sheets to be subjected to the fixation continuously; and
an action control unit that reduces the numerical quantity of the sheets to be subjected to the fixation continuously per unit time if the numerical quantity of the sheets that the quantity determining unit determines exceeds a preset numerical quantity.

11. A temperature controlling method to be performed when fixation is carried out by allowing the sheet to pass through a plurality of heat target areas formed at different positions in a direction orthogonal to a direction to carry a sheet formed with a developer image thereon, comprising:
determining whether at least one sheet to be subjected to the fixation includes a medium size sheet which passes while lying astride the both adjacent heat target areas but passes only one of temperature detection target areas; and
setting the controlled temperature of the heated area corresponding to the temperature detection target area where the sheet does not pass to a temperature higher than the controlled temperature of the heated area corresponding to the temperature detection target area where the sheet passes if it is determined that the medium size sheet is included.

12. The method according to claim 11,
wherein determination whether the medium size sheet is included is carried out by sensing the size of the sheet to be subjected to the fixation.

13. The method according to claim 11,
wherein the determination whether the medium size sheet is included is carried out by detecting the temperature of a press member that carries the sheet in cooperation with a heat member having the heat target area formed thereon and determining on the basis of a change in detected temperature.

14. The method according to claim 11,
wherein determination whether the medium size sheet is included is carried out by detecting the temperatures of a press member that carries the sheet in cooperation with a heat member formed with the heat target areas at positions different from each other in the direction orthogonal to the sheet carrying direction and determining on the basis of a change in detected temperature difference.

15. An image forming apparatus comprising:
an image data acquiring unit that acquires data of image to be formed;
a developer image forming unit that forms a developer image on a sheet on the basis of the image data from the image data acquiring unit;
the fixing device that carries out fixation on the sheet formed with the developer image according to claim 1;
a sheet carrying unit that supplies the sheet to the developer image forming unit and discharges the sheet after the fixation from the apparatus; and
an action control unit that controls an image forming action of the apparatus.

16. The apparatus according to claim 15,
wherein the processing target determining unit includes a sheet size determining unit that determines the size of the sheet to be subjected to the fixation.

17. The apparatus according to claim 16, further comprising a quantity determining unit that determines the numerical quantity of the sheets to be subjected to the fixation continuously,
wherein if the numerical quantity of the sheets that the quantity determining unit determines exceeds a preset numerical quantity, the controlled temperature determining unit determines to change the controlled temperature on the basis of the sheet size that the sheet size determining unit determines.

18. The apparatus according to claim 15,
wherein the processing target determining unit includes a second temperature detector that detects the temperature of the press member, and
the processing target determining unit determines whether the medium size sheet is included on the basis of the temperature change that the second temperature detector detects.

19. The apparatus according to claim 15,
wherein the processing target determining unit includes a plurality of second temperature detectors that are arranged at positions different from each other in the direction orthogonal to the sheet carrying direction and detect the temperatures at a plurality of positions of the press member, and
the processing target determining unit determines whether the medium size sheet is included on the basis of the magnitude of the temperature difference of the temperatures that the plurality of second temperature detectors detect.

20. The apparatus according to claim 19,
wherein the plurality of second temperature detectors are arranged at positions corresponding to the heat target areas that the respective heat source members heat in the direction orthogonal to the sheet carrying direction, and are arranged at positions closer to joints between the heat source members than the first temperature detector.
